(19) United States
(12) Patent Application Publication
(10) Pub. No.: US 2014/0156595 A1
(43) Pub. Date: Jun. 5, 2014

(54) SYNCHRONISATION SYSTEM AND METHOD

(71) Applicant: Metaswitch Networks Ltd., Enfield (GB)

(72) Inventors: Andrew ROSE, Enfield (GB); Martin HARE-ROBERTSON, Enfield (GB)

(73) Assignee: Metaswitch Networks Ltd., Enfield (GB)

(21) Appl. No.: 14/093,141

(22) Filed: Nov. 29, 2013

(30) Foreign Application Priority Data
Nov. 30, 2012 (GB) 1221645.3

(51) Int. Cl. G06F 17/30

(52) U.S. Cl. CPC G06F 17/30575
USPC 707/625

(57) ABSTRACT

A synchronisation system and corresponding method for synchronising a set of records in a first database with a second database which comprises a copy of the set of records. The first database has a transaction log with entries indicating changes made to records in the first database. The second database stores a global version. The synchronisation system comprises at least one processor which is configured to process entries in the transaction log relating to the set of records to record changes from the first database in the second database; and associate the global version with any records written to the second database.

### CROSS-REFERENCE TO RELATED APPLICATIONS

This application claims priority under 35 U.S.C. §119 to GB Application No. 1221645.3, filed Nov. 30, 2012, the entire content of which is hereby incorporated by reference in its entirety.

### BACKGROUND OF THE INVENTION

1. Field of the Invention

The present application relates to a system and method in which a second database is a copy of a first database. The second database can be fully resynchronized with the first database.

2. Description of the Related Technology

It is known to provide more than one copy of a database, with each copy optimized for a different task. For example, a master database may be optimized for online transaction processing (OLTP) and used for day-to-day business operations. A copy of the master database may then be optimized for online analytical processing (OLAP) so that long-running complex queries can be run without impact on the performance of the master database. The copy is kept synchronized with changes to the master database by reading the transaction logs of the master database and updating the copy database as required.

It is possible for the copy database to lose synchronization with the master database for a variety of reasons. These include loss of some transaction logs on the master database and a failure to update the copy database correctly. When the copy has lost synchronization with the master database, the data in it will be inconsistent with the master database and queries run on the copy will not be completely accurate. A method of resynchronizing a copy database with a master database is therefore required. One way of doing this is to dump a copy of the master database, delete all the data in the copy database and recreate it from the copy of the master database. This has the disadvantage of requiring the copy database to be taken offline so it is not available for processing.

US2008/046400A1 discusses resynchronization of databases within a database cluster while maintaining access to the cluster. A resynchronization method is discussed which requires creating a copy of a primary server to a shared network path and then restoring an out of synchronization database from the copy on the shared network path. Access to the out of synchronization database is not possible during the restore process.

### SUMMARY

In accordance with one embodiment, there is provided a synchronization system for synchronizing a set of records in a first database with a second database which may comprise a copy of the set of records. The first database has a transaction log with entries indicating changes made to records in the first database. The second database stores a global version. The at least one processor of the synchronization system is configured to process entries in the transaction log to record changes from the first database in the second database and associate the global version with any records written to the second database.

In another embodiment, there is provided a method of resynchronizing a set of records in first database with a second database which contains a copy of the set of records. The first database has a transaction log with entries indicating changes made to records in the first database, the second database stores a global version, the method may comprise updating the global version to give an updated global version; copying all records in the set of records from the first database to the second database and associating the updated global version with all copied records in the second database; and processing entries in the transaction log relating to the set of records to record changes from the first database in the second database and associating the updated global version with any changed records in the second database during the copying all records.

In a further embodiment, a non-transitory computer readable medium has computer readable instructions embodied thereon, wherein the computer readable instructions, when executed by a processor, instruct the processor to perform a method of resynchronizing a set of records in a first database with a second database which contains a copy of the set of records. The first database has a transaction log with entries indicating changes made to records in the first database, the second database stores a global version. The method may comprise: updating the global version to give an updated global version; copying all records in the set of records from the first database to the second database and associating the updated global version number with all copied records in the second database; and processing entries in the transaction log relating to the set of records to record changes from the first database in the second database and associating the updated global version number with any changed records in the second database during the copying all records.

Further features and advantages of the application will become apparent from the following description of preferred embodiments of the application, given by way of example only, which is made with reference to the accompanying drawings.

### BRIEF DESCRIPTION OF THE DRAWINGS

FIG. 1 shows a diagrammatic representation of a system in which an embodiment of the application can operate;

FIG. 2 shows a process flow chart for a synchronization process of an embodiment of the application;

FIG. 3 shows a process flow chart of a full resynchronization process of an embodiment of the application.

### DETAILED DESCRIPTION OF CERTAIN INVENTIVE EMBODIMENTS

In one embodiment, there is provided a synchronization system for synchronizing a set of records in a first database with a second database which may comprise a copy of the set of records. The first database has a transaction log with entries indicating changes made to records in the first database. The second database stores a global version. The at least one processor of the synchronization system is configured to process entries in the transaction log to record changes from the first database in the second database and associate the global version with any records written to the second database. As a result, each record in the copy of the set of records in the second database has an associated version which is the global version at the time the record was last written to the second database. The association of a version with each record in the second database enables records which have not been modified since the global version was last changed to be identified. This can be advantageous when a resynchronization of the second database with the first database is required. The set of records can be any subset of some records or all records in the first database. For example, in one embodiment the set of records can be at least one table in the first database. In another embodiment, the set of records can be all records in the first database. The global version can be a number in some embodiments. The term “database” is used to refer to any structured collection of data including, but not limited to, SQL databases and proprietary systems in which data is stored. In the case where the database is a general structured collection of data, a record refers to a single data item or entry in the collection of data.

The global version may be independent of the first database. For example, in one embodiment only the second database associates a version with its records, in another embodiment the global version of the second database is independent of any version recorded in the first database. In further embodiments, any version associated with a record in the set of records in the first database is also copied to the second database and is independent of the global version.

In one embodiment, the at least one processor is further configured to: update the global version to give an updated global version; copy all records in the set of records from the first database to the second database and associate the updated global version with each record copied to the second database; and continue to process entries in the transaction log relating to the set of records to record changes from the first database in the second database and associate the updated global version with any changed records in the second database during the copying all records in the set of records. This allows a resynchronization to take place while the second database remains available to process queries. Those queries will benefit from the partial resynchronization to improve the accuracy of the data, although some inaccuracies may remain until the resynchronization process is complete. Where the global version is a number, the global version can be updated by incrementing the number.

The at least one processor may be further configured to delete any records in the second database which are associated with a version other than the updated global version when all records in the set of records have been copied from the first database to the second database. This ensures that the copy of the set of records in the second database only includes records that are also in the first database. In other embodiments, queries on the second database can reference the global version to only include records that are up-to-date after the last resynchronization, or to exclude records with a version that is not the same as the global version.

The at least one processor can be further configured to copy all records in the set of records from the first database to the second database at a lower priority than the processing entries in the transaction log. This ensures up to date data in the second database, even if a record is updated in the first database after it has been copied to the second database during the resynchronization but before the copying all records is complete.

The at least one processor can be further configured to copy all records in the set of records from the first database to the second database when there are no entries in the transaction log awaiting processing. This ensures that the copying of records does not interfere with processing updates from the transaction log. The at least one processor can also be further configured to pause the copying of all records in the set of records from the first database to the second database during processing of entries in the transaction log.

In some embodiments, the second database may comprise a flag that can be set to indicate that a resynchronization is in progress. This allows recovery when a resynchronization fails or does not complete before the second database is restarted. The at least one processor can be further configured to: set the flag indicating that a resynchronization is in progress before updating the global version number; and clear the flag indicating that a resynchronization is in progress after deleting any records associated with a version other than the updated version.

Responsive to the flag indicating that a full resynchronization is in progress may be set when the second database is started, the processor can be configured to restart a full resynchronization of the second database with the first database. This allows recovery when the second database is restarted before resynchronization is complete. By restarting a resynchronization all records in the set of records will be copied again to the second database, so there is no need to consider how far the previous resynchronization had progressed.

The processor can be further configured to overwrite any copies of records already in the second database when copying all records from the first database to the second database. This reduces storage space required during the resynchronization process because there is no need to keep a copy of the data.

In further embodiments, the synchronization system discussed above, with or without optional features also discussed, can be part of a system comprising a first database comprising a set of records and a transaction log; and a second database, which comprises a copy of the set of records and a global version. The second database can comprise a flag that can be set to indicate that a resynchronization is in progress.

According to another embodiment, there is provided a method of synchronizing a set of records in a first database with a second database which contains a copy of the set of records, the first database having a transaction log with entries indicating changes made to records in the first database, the second database storing a global version, the method may comprise processing entries in the transaction log relating to the set of records to record changes from the first database in the second database; and associating the global version with any records written to the second database.

In a further embodiment, there is provided a method of resynchronizing a set of records in first database with a second database which contains a copy of the set of records. The first database has a transaction log with entries indicating changes made to records in the first database, the second database stores a global version, the method may comprise updating the global version to give an updated global version; copying all records in the set of records from the first database to the second database and associating the updated global version with all copied records in the second database; processing entries in the transaction log relating to the set of records to record changes from the first database in the second database and associating the updated global version with any changed records in the second database during the copying all records; and deleting any records in the second database associated with a version other than the updated global version when all the records in the set of records have been copied from the first database to the second database.

These methods can be provided with features corresponding to the configuration of the processor of the first aspect described above, with or without any of the optional features also described.

In other embodiments, a computer program comprises computer program instructions that, when executed by a processor, instruct the processor to perform the methods discussed above. Further embodiments may provide a non-transitory computer readable medium on which the computer readable instructions are embodied.

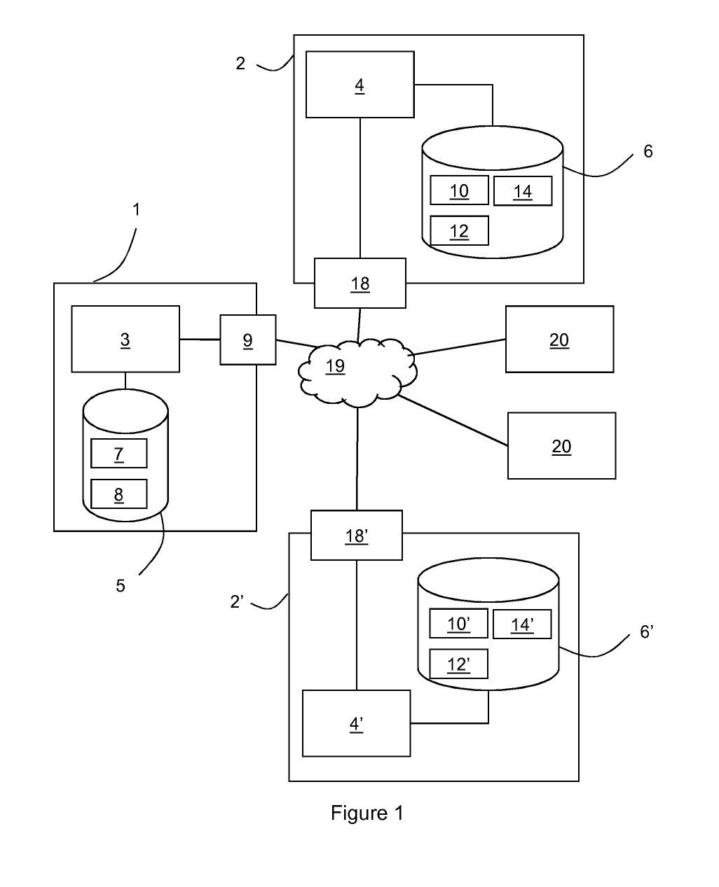

Referring now to the drawings, FIG. 1 depicts a diagrammatic representation of a system in which the present application can operate. The system includes an application server 1 which may comprise one or more processors 3. The processor 3 is controlled by software in memory store 5, including at least an operating system 7 and application software 8. The application server 1 also has at least one connection 9 for transmitting and/or receiving data over a network 19. Although one application server 1 is depicted, other embodiments may include two or more application servers. Two or more application servers may be provided for redundancy and fail-over protection.

The system also includes a first element 2 and a second element 2′ which can each be server or other computing device. In this embodiment, the first element 2 and second element 2′ are each a storage server.

The first element 2 is a dedicated storage device which may comprise a processor 4, for example a central processing unit (CPU), a microprocessor, System on Chip, System in Package or an application specific integrated circuit. Although a single processor is illustrated and described, other embodiments can use more than one processor. The processor 4 is for example controlled by software stored in a memory store 6, including at least an operating system 10 and application software 12. The memory store can be any form of non-transitory storage, for example magnetic storage. The memory store 6 also includes a database 14. In this embodiment, the database 14 is a collection of data in a proprietary format which is optimized for OLTP. In other embodiments, the database 14 can be, for example, any structured collection of data such as a collection of records, a relational database including at least two data tables, or a general collection of data, where each data item can be considered to be a record for the purposes of this description. Each record has an associated unique identifier. The database 14 may include a transaction log that stores information of all changes made to the database.

The first element 2 also has at least one connection 18 for transmitting and/or receiving data over the network 19. Network 19 can be any network suitable for the transmission and/or reception of data, such as an Ethernet network or the internet.

The second element 2′ is a database server in this embodiment. It has features similar to the first element, for such features the same reference is used with the addition of a prime (e.g. processor 4′ is a features similar to processor 4′). The second element 2′ also may comprise a processor 4′, memory store 6′ and at least one network connection 18′. However, while the memory store of the second element may comprise an operating system 10′, application software 12′ and a database 14; a transaction log is not required in database 14′ of the second element 2′. It should also be noted that the operating system 10′, application software 12′ and database 14′ of the second element 2′ need not be same as the first element 2. The second element 2′ is optimized for OLAP and this can require different software and database formats. In this embodiment the second element 2′ runs an SQL database, such as the open source PostgreSQL. In other embodiments, the second element 2′ may run other software to function as a storage server with a different database format, such as a collection of structured data in a proprietary format.

The application server 1 runs processes which write to the database 14 of the first element 2 by transmitting data over the network 19 to the first element 2. Other devices 20 can access the first element 2 and the second element 2′ using the network 19 to access and/or request processing of data stored in the databases 14, 14′, for example a request may be submitted via the application server 1 or directly to the first element or the second element. For example the other devices can be computing devices or any other device which requires access to databases 14, 14′.

For the purposes of simplifying the explanation of the inventive concepts disclosed herein, various embodiments will be described in the context of operations on databases 14, 14′ which comprise a single table having a plurality of records. In other embodiments the databases may contain more than one table or data stored in other formats than tables, including a general collection of structured data.

The database 14 in the first element 2 is optimized for OLTP and comprises a plurality of records. The processor 4 is configured by instructions in the application software 12, to interact with the records in the database 14 to access and/or update the data as required depending on instructions received over the network 19 from processes running on the application server 1. When any of the records 10 in the database 14 are changed by operations on the database 14, the information of the changes is recorded in the transaction log of the database 14 under instructions received from the application server. In this embodiment, the transaction log stores the unique identifier of the record which has been changed and the time of the change. In other embodiments different information can be stored in the transaction log, for example a copy of every changed record.

The database 14′ in the second element 2′ is a copy of the database 14 in the first element 2 and is optimized for OLAP. In this embodiment, the database 14′ in the second element 2′ contains copies of all the records in the database 14 of the first element 2. In other embodiments, the database 14′ need not contain a copy of all records in the database 14 of the first element 2, for example the database 14′ of the second element 2′ may contain a copy of a set of the records. A global version number and a flag, which indicates whether a resynchronization is in progress, are stored in the database 14′ of the second element 2′ independent of any copy data. For example global version number and flag can be stored in global metadata of the database 14′ of the second element 2′.

Every record in the database 14′ of the second element 2′ is associated with a version, which is the global version number at the time the record was last written to the database 14′ of the second element 2′. A write is any operation which causes the record to change, it can occur when a record is created or updated. The association of each record with a version can be accomplished in any suitable way, for example each record can be augmented or appended with the version.

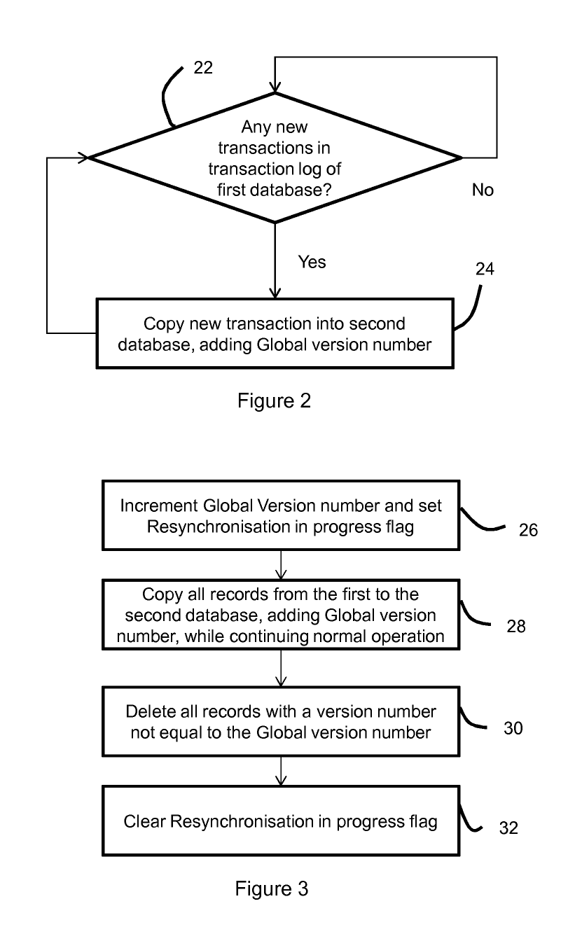

In normal operation, the database 14′ of the second element 2′ is maintained as an accurate copy of the database 14 of the first element 2 by executing a process as depicted in FIG. 2. This process can be executed by the processor 4′ of the second element, in other embodiments it can be executed by a processor remote from the second element 2′, for example the processor 3 of the application server 1. The transaction log of the database 14 of the first element 2 is monitored (step 22 in FIG. 2). If there are any new transactions in the transaction log the record referenced by each new transaction is copied to the database 14′ of the second element 2′ and any changed or new records are associated with the current value of the global version number (step 24 in FIG. 2). Thus, in normal operation the database 14′ of the second element 2′ is synchronized with the database 14 of the first element 2. Between resynchronizations of the database 14 of the first element 2 with the database 14′ of the second element 2′, the global version number does not change. It is therefore possible for a single record to be updated several times by the synchronization process of FIG. 2 and each time the record is associated with the same value the global version number.

Despite the process of FIG. 2 it is possible for the database 14′ of the second element 2′ to become out of synchronization with the database 14 of the first element 2, so that it is no longer an accurate copy. This may occur, for example, because data in the transaction log was lost before the database 14′ of the second element 2′ could be updated, because of a failure to update a record in the database 14′ of the second element or because of a general fault in the synchronization process. When data inconsistency is identified, for example by an unexpected result in analysis of the data in the database 14′ of the second element 2′, a resynchronization is required. Data inconsistency can have three types: (i) a record in the database 14′ of the second element 2′ is not the same as the corresponding record in the database 14 of the first element 2; (ii) a record in database 14 of the first element 2 is not present in the database 14′ of the second element 2; and (iii) a record which has been deleted from the database 14 of the first element 2 is still present in the database 14′ of the second element 2′. All three of these types of data inconsistency are corrected by a resynchronization.

In this embodiment resynchronization of the database 14′ of the second element 2′ can take place without needing to take the database 14′ offline. This allows the database 14′ to remain available for queries during the resynchronization. Resynchronization can take a long period of time, during which it can be desirable to receive results from the database 14′ of the second element 2′ rather than no results at all, even though these results may not be completely accurate. Resynchronization while keeping the database 14′ of the second element 2′ online and available for queries is enabled by the global version number and the version which is associated with every record in the database 14′ of the second element 2′.

When a resynchronization of the database 14′ of the second element 2′ is required, the process depicted in FIG. 3 is executed. This process can be executed by the processor 4′ of the second element 2′, in other embodiments it can be executed by a processor remote from the second element 2′, for example by the processor 3 of the application server 1. First, at step 26, the global version number is incremented and the resynchronization in progress flag is set to a value of true in the database 14′ of the second element 2′. Incrementing the global version number enables all records written since the start of the resynchronization to be identified.

Next, at step 28, all the records in the database 14 of the first element 2 are copied to the database 14′ of the second element 2′ and associated with the incremented global version number. While the copying is in progress “normal” operation of the database 14′ of the second element 2′ continues. For example, the database 14′ of the second element 2′ will continue to be updated as new transactions appear in the transaction log of the database 14 of the first element 2. Likewise, queries can continue to run on the database 14′ of the second element 2′. Any queries run during the resynchronization will benefit from the portion of the database which has been resynchronized at that point. All records copied by the resynchronization contain the latest data at the point they were copied and are then kept updated. Therefore, although there may still be some inaccuracies until the resynchronization is complete, running a query during resynchronization will benefit from improved data accuracy of the records copied so far.

To facilitate the normal operation of the database 14′ of the second element 2′ during the resynchronization process, the copying of records is given a lower priority than other tasks. In one embodiment, the copying of records is only carried out when there are no unprocessed transactions in the transaction log of the database 14 of the first element 2. For example, copying of records can be paused when there are transactions in the transaction log of the database 14 of the first element 2 that require updating of the database 14′ of the second element 2′.

The records can be copied in any suitable way. For example, each record in the database 14 of the first element 2 may simply be copied sequentially to the database 14′ of the second element 2′. Copying the records can make use of the unique identifier to determine whether a record already exists in the database 14′ of the second element 2′. If a record already exists in the database 14′ of the second element it is overwritten by the new copy, otherwise a new record is created. This has a benefit that it does not require additional storage space to be allocated for a dump of the database 14 of the first element 2′. In fact, very little additional storage space is likely to be needed during a resynchronization because only new records not already in the database 14′ of the second element 2′ will create an additional storage requirement.

After all the records have been copied, the database 14′ of the second element 2′ contains an up to date copy of all records in the database 14 of the first element 2. This is true even if records have been updated database 14 of the first element 2 since the resynchronization began because the normal operation to update records in the database 14′ of the second element 2′ from the transaction log is given a higher priority. For example, if a record was updated in the database 14 of the first element 2, after may be copied to the database 14′ of the second database 2′ but before all records have been copied, it will be updated from the transaction log 12 according to the process of FIG. 2, which runs throughout the resynchronization process of FIG. 3. Therefore, all records in the database 14′ of the second element 2′ are the same as corresponding records in the database 14 of the first element 2 and any records in the database 14 of the first element not previously in the database 14′ of the second element 2′ will now be in the database 14′ of the second element 2′. This addresses possible data inconsistency (i) and (ii) discussed above.

There remains the possibility that the database 14′ of the second element 2′ contains records which have been deleted from the database 14 of the first element 2 (data inconsistency (iii) discussed above). This is addressed by deleting any records in the database 14′ of the second element 2′ which have a version that is not the same as the global version number at step 30. The addition of the version to records in the database 14′ of the second element 2′ therefore enables records for deletion to be identified with requiring anything more than a comparison of the version associated with a record and the current global version number.

Finally, at step 32, the Resynchronization in progress flag 18 is cleared or set to False. The process of FIG. 2 continues to operate to synchronize any further changes.

The resynchronization in progress flag 18 allows the database 14′ of the second element 2′ to recover from a restart before a resynchronization is complete. For example, a power failure may require shutting down the database 14 of the second element 2′. When the database 14′ of the second element 2′ is started or restarted a check of the value of the resynchronization in progress flag is made. If it is set or true then the global version number is incremented and copying all records from the database 14 of the first element 2 begins again from the start (i.e. at step 28 in the process of FIG. 3). This allows robust recovery from a failure during a resynchronization.

Throughout the process of resynchronization, the database 14′ of the second element 2′ remains online and available for use. There is no period during the resynchronization where it needs to be taken offline or is inaccessible. For example, there is no period of inaccessibility while the second element 2′ switches to using a new copy of the database.

The processes of FIGS. 2 and 3 allow the database 14′ of the second element 2′ to be synchronized and resynchronized with the database 14 of the first element 2. The processes can be carried by the processor 4′ of the second element 2′ in some embodiments, with the processor 4′ interacting with the processor 4 of the first element 2 to read the transaction log as required. The processes can also be carried out by a processor in device other than the second element in some embodiments.

The above embodiments are to be understood as illustrative examples of the application. Further embodiments of the application are envisaged. For example, in some embodiments the resynchronization in progress flag may be omitted from the second database. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the application, which is defined in the accompanying claims.

What is claimed is:

1. A synchronization system for synchronizing records, comprising:
a memory configured to store a first database comprising a set of records, and a second database comprising a copy of the set of records, wherein the first database includes a transaction log with entries indicating changes made to records in the first database, and wherein the second database includes a global version;
at least one processor configured to:
process entries in the transaction log relating to the set of records in the first database to record changes from the first database in the second database; and
associate the global version with any records written to the second database.

2. The synchronization system of claim 1, wherein the global version is independent of the first database.

3. The synchronization system of claim 1, wherein, when a resynchronization of the second database with the first database is required, the at least one processor is further configured to:
update the global version to give an updated global version;
copy all records in the set of records from the first database to the second database and associate the updated global version with each record copied to the second database; and
continue to process entries in the transaction log relating to the set of records to record changes from the first database in the second database and associate the updated global version with any changed records in the second database during the copying all records in the set of records.

4. The synchronization system of claim 3, wherein the at least one processor is further configured to delete any records in the second database which are associated with a global version other than the updated global version when all records in the set of records have been copied from the first database to the second database.

5. The synchronization system of claim 4, wherein the at least one processor is further configured to copy all records in the set of records from the first database to the second database at a lower priority than the processing entries in the transaction log.

6. The synchronization system of claim 4, wherein the at least one processor is further configured to copy all records in the set of records from the first database to the second database when there are no entries in the transaction log awaiting processing.

7. The synchronization system of claim 5, wherein the at least one processor is further configured to pause the copying of all records in the set of records from the first database to the second database during processing of entries in the transaction log.

8. The synchronization system of claim 1, wherein the second database comprises a flag indicative of a resynchronization in progress, and wherein the at least one processor is further configured to:
set the flag before updating the global version; and
clear the flag after deleting any records associated with a version other than the updated version.

9. The synchronization system of claim 8, wherein the at least one processor is further configured to, in response to the flag being set and a failure in the second database during synchronization, restart a resynchronization of the second database with the first database.

10. The synchronization system according to claim 3, wherein the processor is further configured to overwrite any copies of records already in the second database when copying all records in the set of records from the first database to the second database.

11. A method of resynchronizing a set of records in a first database with a second database which contains a copy of the set of records, the first database having a transaction log with entries indicating changes made to records in the first database, the second database storing a global version, the method comprising:
updating the global version to give an updated global version;
copying all records in the set of records from the first database to the second database and associating the updated global version number with all copied records in the second database; and
processing entries in the transaction log relating to the set of records to record changes from the first database in the second database and associating the updated global version number with any changed records in the second database during the copying all records.

12. The method of claim 11, further comprising deleting any records in the second database associated with a global version other than the updated global version when all the records in the set of records have been copied from the first database to the second database.

13. The method of claim 11, wherein the copying all records in the set of records takes place at a lower priority than the processing any unprocessed entries in the transaction log.

14. The method of claim 13, wherein the copying all records in the set of records takes place when there are no entries in the transaction log relating to the set of records awaiting processing.

15. The method of claim 13, wherein the copying all records in the set of records is paused during processing entries in the transaction log.

16. The method of claim 11, wherein the copying all records in the set of records from the first database to the second database overwrites any copies of records already in the second database.

17. The method of claim 11, further comprising:
setting a flag indicating that a resynchronization is in progress prior to updating the global version; and
clearing the flag indicating that a resynchronization is in progress after processing the entries in the transaction log.

18. A method of claim 17, further comprising:
detecting the flag indicating that a resynchronization is in progress being set at the time the second database is started;
in response to the flag being detected:
updating the global version to give a second updated global version;
copying all records in the set of records from the first database to the second database and associating the second updated global version number with all copied records in the second database;
processing entries in the transaction log relating to the set of records to record changes from the first database in the second database and associating the second updated global version number with any changed records in the second database during the copying all records; and
deleting any records in the second database associated with a global version other than the second updated global version when all the records in the set of records have been copied from the first database to the second database,
wherein clearing the flag indicating that a resynchronization is in progress after processing the entries in the transaction log comprises clearing the flag after deleting the records.

19. A non-transitory computer readable medium having computer readable instructions embodied thereon, wherein the computer readable instructions, when executed by a processor, instruct the processor to perform a method of resynchronizing a set of records in a first database with a second database which contains a copy of the set of records, the first database having a transaction log with entries indicating changes made to records in the first database, the second database storing a global version, the method comprising:
updating the global version to give an updated global version;
copying all records in the set of records from the first database to the second database and associating the updated global version number with all copied records in the second database; and
processing entries in the transaction log relating to the set of records to record changes from the first database in the second database and associating the updated global version number with any changed records in the second database during the copying all records.
